(19) United States
(12) Patent Application Publication
(10) Pub. No.: US 2015/0260656 A1
(43) Pub. Date: Sep. 17, 2015

(54) METHOD FOR DETECTING ANALYTES

(71) Applicant: SPECTROPHON LTD., Rehovot (IL)

(72) Inventors: Gleb Zilberstein, Rehovot (IL); Shmuel Bukshpan, Ramat Hasharon (IL)

(73) Assignee: SPECTROPHON LTD., Rehovot (IL)

(21) Appl. No.: 14/436,901

(22) PCT Filed: Oct. 22, 2013
(86) PCT No.: PCT/IL2013/050847

§ 371 Date: Apr. 20, 2015

Related U.S. Application Data
(60) Provisional application No. 61/716,686, filed on Oct. 22, 2012.

(51) Int. Cl. G01N 21/78

(52) U.S. Cl. CPC G01N 21/78; G01N 2201/12

(57) ABSTRACT

Disclosed is a method for detecting at least one analyte in a sample, which comprises applying a variable optical filter, comprising a chemochromic material that is sensitive to the analyte, to an optical lens of a camera, an optical lens of a multi-cell photosensor and/or to a multi-cell photosensor, contacting at least part of the chemochromic material with the sample, exposing at least part of the variable optical filter to electromagnetic radiation after at least part of the chemochromic material was exposed to the sample to obtain digital data regarding the chemochromic material that was contacted with the sample and processing the digital data and comparing said digital data with a reference.

### FIELD OF THE INVENTION

The invention is directed to a method for detecting an analyte comprising the application of a colorimetric variable optical element comprising a chemochromic material to a photosensor or to a lens thereof, exposure to an electromagnetic radiation and procession of the digital data obtained.

### BACKGROUND OF THE INVENTION

Methods of colorimetric detection and sensing of specific chemical analytes are widely known in the art. Such methods are based on a process that induces a reversible or an irreversible change in the optical properties (color, transparency, light scattering intensity, fluorescence with external excitation, chemoluminescence, thermoluminescence, plasmon based light scattering etc.), of specific active compounds when exposed to a chemical analyte. Many natural compounds are known to exhibit chromism, and many artificial compounds with specific chromism have been synthesized and utilized as chromic sensors.

Detection and quantification of the changes in the optical parameters of a chemochromic material allows the measurement of the quantity of a specific analyte to which the chemochromic material was exposed. Mostly, each analyte is detected by a certain chromic sensor and therefore, such detection methods tend to be highly specific.

Chromic sensing has been widely utilized in order to identify the presence or level of specific analytes in liquid solutions or and in gas phase mixtures or and in solid phase media.

Known in the art are also attachable or integrated electronic sensors that can be attached to or integrated in various electronic devices, including mobile electronic devices, such as cell phones, wherein the data regarding the analytes is collected and analyzed by the attachable electronic sensor. Examples of such attachable/integrated sensors are found, for example, in US 2009/0325639, US 2004/0081582 and JP 2005/5086405.

iBreath Alcohol Breathalyzer (iBAB) is an example of a personal alcohol measuring module that connects to an iphone. The iBAB connects to the iphone for power and for possible transmission of the results to third parties; however, the detection and analysis of the alcohol content if performed in the iBAB itself, not on the iphone.

Other methods of utilizing chemochromic materials coated on optical fibers or LED based sensors are known.

Thus, there is a need in the art for an inexpensive, highly available, possibly disposable, sensor for personal use that may be used to detect various types of analytes easily, using widespread technology.

### SUMMARY OF THE INVENTION

Some embodiments are directed to a method for detecting at least one analyte in a sample, the method comprising

applying a variable optical filter, which comprises a chemochromic material that is sensitive to the analyte, to an optical lens of a camera, an optical lens of a multi-cell photosensor or a multi-cell photosensor;
contacting at least part of the chemochromic material with the sample;
exposing at least part of the variable optical filter to electromagnetic radiation after at least part of the chemochromic material was exposed to the sample to obtain digital data regarding the chemochromic material that was contacted with the sample; and
processing the digital data and comparing said digital data with a reference.

Further embodiments are directed to a kit comprising a variable optical filter, which comprises a chemochromic material that is sensitive to an analyte, an applicator or means for applying the variable optical filter to an optical lens of a camera or to a multi-cell photosensor, wherein the kit, the variable optical filter as packaged in the kit or both kit and variable optical filter as packaged in the kit are impermeable to the analyte.

Additional embodiments are directed to a device comprising at least one embedded multipixel photo electronic sensor coupled to a variable optical element.

Further embodiments are directed to a method for detecting at least one analyte in a sample, the method comprising:
attaining a variable optical filter, which comprises a chemochromic material that is sensitive to the analyte;
contacting at least part of the chemochromic material with the sample;
applying the variable optical filter to an optical lens of a camera and/or to a multi-cell photosensor;
exposing at least part of the variable optical filter to electromagnetic radiation to obtain digital data regarding the chemochromic material that was contacted with the sample; and
using image analysis software to compare the digital data with a reference.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details

of the invention in more detail than is necessary for a fundamental understanding of the invention, the description taken with the drawings making apparent to those skilled in the art how the several forms of the invention may be embodied in practice.

FIG. 1 is a calibration curve for mercaptan in concentrations of 1-6 ppm;

FIG. 2 is a calibration curve for mercaptan in concentrations of 0-1 ppm;

FIG. 3 is a calibration curve for alcohol in concentrations of 0-50 ppm;

FIG. 4 is a calibration curve for the bovine serum albumin (BSA) protein in amounts of between 100-1000 ng;

FIG. 5 is a calibration curve for Bovine Serum Albumin (BSA) in amounts of between 1 μg-1 mg BSA;

FIG. 6 is a calibration curve for acetone in concentrations of between 100-600 ppb;

FIG. 7 is a calibration curve for acetone in concentrations of between 600-2000 ppb;

FIG. 8 is a calibration curve for pH measurement in the range of between 7-14 pH;

FIG. 9 is a calibration curve for free chlorine in amounts of between 10 ng-1 mg;

FIG. 10 is a calibration curve for aliphatic amines in amounts of between 100-1000 ng and 1 μg-1 mg;

FIG. 11 presents the results of a fluorescence analysis of DNA under external UV excitation in ranges of between 10-1000 ng;

FIG. 12 presents an embodiment of a system including a digital camera, to which a chemochromic variable optical element (filter) was applied, and an external UV source;

FIG. 13 is a calibration curve for lead acetate in concentrations of between 1 nM-1 mM;

FIG. 14 presents an embodiment of a variable optical element (for example filter) which may be attached to a digital camera lens;

FIGS. 15A and 15B present circular and rectangular arrays of variable optical filters, respectively, which can be moved manually or mechanically;

FIG. 16A presents an embodiment of a variable optical element, which may be coupled to a complementary metal oxide semiconductor (CMOS) chip, reset to its original optical state after being exposed to an analyte by IR radiation;

FIG. 16B presents an embodiment of a variable optical element, which may be coupled to a CMOS chip, reset to its original optical state after being exposed to an analyte by a heating element;

FIG. 16C presents an embodiment of a variable optical element, which may be coupled to a CMOS chip, reset to its original optical state after being exposed to an analyte by ultrasound;

FIGS. 17A, 17B, 17C, 17D, 17E and 17F presents various embodiments relating to different types of variable optical elements, which may be coupled to CMOS chips;

FIG. 18 presents an embodiment of an array of CMOS chips coupled to variable optical elements; and

FIG. 19 presents an embodiment of constant volume sampling devices.

### DETAILED DESCRIPTION OF THE INVENTION

Certain embodiments of the invention are directed to a method for detecting at least one analyte in a sample, the method comprising

applying a chemochromic variable optical element, which comprises a chemochromic material that is sensitive to the analyte, to the optical lens of a camera, to the optical lens of a multi-cell photosensor or to a multi-cell photosensor or in close or near proximity thereof;
contacting at least part of the chemochromic material with the sample;
exposing at least part of the variable optical element to electromagnetic radiation after at least part of the chemochromic material was contacted with the sample to obtain digital data regarding the chemochromic material that was contacted with the sample; and
processing the digital data and comparing it with a reference.

Unless specifically stated otherwise, references herein to any type of camera are meant to include also any appropriate type of multi-cell photosensors. The multi-cell photosensor may be or may include a digital camera or may be any other appropriate sensor. The multi-cell photosensor may or may not include an optical lens. When the multi-cell photosensor includes an optical lens, the variable optical element may be placed in reference to that lens, as detailed herein. When the multi-cell photosensor does not include an optical lens, the variable optical element may be placed in from of, in back of, to the side of the multi-cell photosensor or directly on the multi-cell photosensor, ensuring that it is placed such that electromagnetic radiation will pass therethrough and that digital data may be obtained therefrom so as to record any changes made to the chemochromic material in the variable optical element.

Unless specifically stated otherwise, references herein to the use of cameras, e.g., the implementation of “screen shots” should be understood to include any type of exposure of the variable optical element to any type of electromagnetic radiation. Unless specifically stated otherwise, references herein to using image analysis software to compare the digital data obtained to a reference may include any appropriate type of digital processing, not only image analysis. According to some embodiments, the digital data obtained is processes and possibly compared to a reference using image analysis software.

Unless specifically stated otherwise, references herein regarding exposing the variable optical element and/or the chemochromic material to the analyte and/or the sample are interchangeable with contacting the variable optical element and/or the chemochromic material with the analyte/sample.

Unless stated otherwise, the terms “variable optical element”, “variable optical filter” are interchangeable herein. According to some embodiments, the chemochromic material comprised in the variable optical filter reacts with the analyte by any known mechanism, such as changes in color, transparency, light scattering intensity, fluorescence with external excitation, chemoluminescence, thermoluminescence, plasmon based light scattering, or any combination thereof.

According to the above embodiment, the chemochromic variable optical filter is applied in close/near proximity to the optical lens of the camera, i.e., outside the depth of field range of the camera, which results in a spread of any geometrical details over the matrix of the detector. According to such an embodiment, a screen shot taken by the camera after the exposure of the chemochromic material to the analyte is compared to a separate reference. It is noted that herein, any reference to placing a variable optical element on the optical lens of the camera includes placing such an element in the close/near proximity thereof.

According to some embodiments, the variable optical element may be attached to the body of the camera in close proximity by any type of appropriate holder. According to some embodiments, the holder positions the variable optical element at least 0.5 cm away from the lens of the camera. According to further embodiments, the holder positions the variable optical element at least 1.0 cm from the lens of the camera. According to further embodiments, the holder positions the variable optical element between 0.1-10.0 cm from the lens of the camera. According to further embodiments, the holder positions the variable optical element between 0.1-0.5 cm from the lens of the camera. According to further embodiments, the holder positions the variable optical element between 0.5-1.0 cm from the lens of the camera. According to further embodiments, the holder positions the variable optical element between 1.0-2.0 cm from the lens of the camera. According to further embodiments, the holder positions the variable optical element between 2.0-3.0 cm from the lens of the camera. According to further embodiments, the holder positions the variable optical element between 3.0-4.0 cm from the lens of the camera. According to further embodiments, the holder positions the variable optical element between 4.0-5.0 cm from the lens of the camera. According to further embodiments, the holder positions the variable optical element between 5.0-6.0 cm from the lens of the camera. According to further embodiments, the holder positions the variable optical element between 6.0-7.0 cm from the lens of the camera. According to further embodiments, the holder positions the variable optical element between 7.0-8.0 cm from the lens of the camera. According to further embodiments, the holder positions the variable optical element between 8.0-9.0 cm from the lens of the camera. According to further embodiments, the holder positions the variable optical element between 9.0-10.0 cm from the lens of the camera.

According to some embodiments, the analyte in the variable optical filter is exposed to is in gas form, aerosol, droplets, spray, plasma, flame, airborne liquid or solid particles or any other form that may be carried in the surrounding atmosphere. According to further embodiments the analyte may be any type of medium, such as liquid, solid, gel, cream, or the like.

According to some embodiments, the variable optical filter is placed on the surface of the lens digital camera before being exposed to the analyte. According to other embodiments, the variable optical filter is placed on the surface of the digital lens after the variable optical filter was exposed to the analyte. According to some embodiments, the variable optical element is placed on the lens of the camera after being exposed to the analyte after the time required for the color change chemical reaction to be completed. The variable optical element may be exposed to the analyte by spreading the analyte on the variable optical element, using, e.g., a Q-tip swab, or the like, by dipping the variable optical element into a vessel containing the analyte, by spraying the analyte onto the variable optical element, or by any other appropriate means.

The term “reference” is defined herein to relate to any digital media that includes data/parameters regarding a variable optical filter and/or material on a variable optical filter that was not exposed to the analyte. For example, the reference may be a screen shot taken after the variable optical filter was applied to the optical lens of the camera, though before the exposure thereof to the analyte. According to other embodiments, the reference may be a reference picture stored in digital memory, which was taken through a variable optical filter that was not exposed to the analyte.

The screen shot of the variable optical element, taken by the digital camera, may be illuminated or radiated by any appropriate electromagnetic radiation, including visible light, UV, IR, X-rays, microwaves, etc. Accordingly, any reference to “light” or the like herein, should be understood to include any type of electromagnetic radiation, as well as electroluminescnece, chemoluminescence, fluorescent materials with long period of postluminescnce), unless specifically noted otherwise. According to some embodiments, the illumination means are external to the camera. According to further embodiments, the illumination or radiation means are internal, such that they are a physical part of the camera itself or of any part of the device the camera is incorporated into.

Further embodiments of the invention are directed to a variable optical element that is transparent or translucent, such that the electromagnetic radiation probes the whole active volume/thickness of the variable optical element, so that the electromagnetic radiation passes through the entire thickness of the variable optical element, operating by transmission, not reflection and/or refraction. The use of transmission, rather than refraction/reflection, enhances the sensitivity of the measurement. Such enhancement allows the detection of miniscule amounts of the analyte, which could not have been detected using reflection and/or refraction methods.

In order to implement transmission, the variable optical element is prepared such that it is transparent/translucent. Further, according to some embodiments, the chemochromic material is dispersed throughout the entire thickness of the variable optical element and the changes caused to the chemochromic material due to the contact thereof with the analyte occur throughout that thickness. According to such embodiments, the filter is prepared such that it is porous, thereby allowing the penetration of the measured sample to the entire thickness thereof. According to some embodiments, the variable optical element is prepared by embedding chemochromic material into and onto filter paper, e.g. by dipping, thereby allowing the chemochromic material to be dispersed throughout the thickness of the filter paper and further allowing the sample to contact the chemochromic material throughout the thickness of the prepared variable optical element via the natural pores found in the filter paper.

According to some embodiments, the optical variable element has a thickness of at least about 10 nm. According to further embodiments, the optical variable element has a thickness of about 10 cm at the most.

According to some embodiments, the materials used to detect the analyte, are not sensitive to any materials other than the analyte itself, including any type of humidity, such as water, water vapor, water droplets, water aerosol and the like. According to such embodiments, the variable optical elements are not sensitive to humidity and therefore, may be used under any surrounding conditions, including humid conditions.

The method detailed herein may be used by professional operators for any necessary means, such as medical testing, law enforcement and the like. According to further embodiments, the method is considered to be social method for use by any individual or group of laymen desiring to detect any condition, such as, without limitation, alcohol consumption or bad breath.

According to some embodiments, the camera is a digital camera. According to further embodiments, the camera is part of any type of mobile or immobile device, such as a cellphone, tablet, portable computer, smartphones, desktop computer and the like. According to some embodiments, the camera is part of a device that includes image analysis software. According to other embodiments, the camera is connected to any device that includes image analysis software. According to some embodiments, the camera related to herein may be a self-standing photo multipixel (matrix) electronic image sensor with image processing capability and display. Since many known devices, such as smart phones and tablets, include a digital camera and can be easily installed with image analysis software, the method of the invention may be simply used by any layman in possession of the chemochromic variable optical filter.

According to some embodiments the variable optical filter is designed to be disposable. According to further embodiments, the variable optical filter is designed for multiple uses. For that use the variable optical filter is designed with proper chemochromic material and microstructure enabling fast reset and removal of attached analyte traces. Resetting the variable optical filter may be performed by any appropriate means, such as heating (using hot air, IR, transparent conductor heaters, e.g., as a backing on the variable optical filter and the like), mechanical vibration, ultrasound, chemical reaction, microfluidic system, microwave, a diode and the like or any combination thereof, such embodiments allow multiple utilization of the variable optical element.

As mentioned above, after the chemochromic variable optical filter is exposed to the sample, at least one picture is taken. According to some embodiments, the method for detecting the analyte includes taking two pictures, one before the chemochromic variable optical filter is exposed to the sample, used as the reference, and one after. The two pictures are then compared to one another using any appropriate image analysis software, thus, the change, if any, in the chemochromic variable optical filter due to its exposure to the sample, is detected, providing information regarding the presence, and when required the amount, of the analyte in the sample. A larger difference between the two pictures should indicate a higher concentration of the analyte in the sample.

According to another embodiment, only one screen shot is taken, after the exposure of the filter to the analyte. According to such embodiments, the screen shot obtained after the exposure to the analyte is compared to a reference screen shot stored in memory.

According to further embodiments, when in the far proximity mode, i.e., when the picture is in the depth of field of camera, certain areas of the chemochromic variable optical filter have chemochromic material on them, while other areas do not. If such chemochromic variable optical filters are used, the variable optical filter is exposed to the sample and one picture is taken. After taking a picture, the areas of the picture, corresponding to areas on which the chemochromic variable optical filter does not have chemochromic material, are used as the reference. Thus, those reference areas are compared to areas of the picture corresponding to areas on which the chemochromic variable optical filter has chemochromic materials, using any appropriate image analysis software. According to some embodiments, the above areas may be in any geometry (including, though not limited to ring, dots, lines, random shapes etc.).

According to yet another embodiment, the chemochromic variable optical filter is partially covered by a mask. The mask may be prepared from any appropriate material that is impenetrable to the analyte. In some embodiments, the mask may include (PE), polymethylmethacrylate (PMMA) or polyethylene terephthalate (PET), and may be applied to the chemochromic variable optical filter by any appropriate means, such as, lamination, adhesives etc. According to further embodiments, the masked areas may be of any appropriate geometry (including, though not limited to ring, dots, lines, random shapes etc.). According to this embodiment, since the chemochromic variable optical filter is partially covered by a mask that the analyte cannot penetrate, only the areas that are not covered by a mask are affected by the analyte. A picture is taken after exposure and the areas of the frame corresponding to the areas of the variable optical filter covered by the mask are used as the reference. Thus, the masked reference areas are compared to those that are not, thereby enabling the image analysis software to detect the analyte by the changes to the chemochromic material exposed thereto. It is noted that the use of such a mask is possible when a high definition image is obtained, i.e., when the picture is in the depth of field of camera. According to some embodiments, the mask is transparent/translucent and thus does not alter the picture taken by the digital camera in any way. According to further embodiments, the mask is both transparent and matt, so that it does not affect the picture even if the picture was taken with a flash, in direct sunlight or under the influence of any light source.

According to some embodiments, the areas on the chemochromic variable optical filter comprising chemochromic material, possibly the entire variable optical filter, are covered by a mask that is removed in order to expose the chemochromic material to the sample. According to such an embodiment, a reference picture is taken before the mask is removed and a second picture is taken after the mask is removed. Since initially the chemochromic material is covered by a mask, the variable optical filter may be applied to the optical lens of the camera even in an environment comprising the analyte. According to further embodiments, the mask is only partially removed from the variable optical filter in order to expose part of the chemochromic material to the analyte. According to further embodiments, the mask is removed, partially or fully, for exposure to the analyte, and returned to the variable optical filter before obtaining the frame.

As mentioned above, the method of the invention measures the differences between digital data regarding the chemochromic material that was exposed to the sample and a reference. In order for the differences between the digital data regarding the chemochromic material exposed to the sample and the reference to be attributed almost completely to the exposure of the chemochromic material to the analyte, according to some embodiments, the user is instructed to take two pictures in the same visual setup, i.e., at the same angle, against the same background, in the same lighting conditions, same white balance parameters, same exposure time etc. The type of background against which the picture is taken, as well as the lighting conditions, may also influence the difference between the two pictures or the different areas in the pictures and therefore, according to some embodiments, the background and/or the lighting conditions are set so that the differences between the two pictures, or the different areas in the same picture, to be attributed almost completely to the exposure of the chemochromic material to the analyte. According to further embodiments, the user is instructed to take one picture after exposure under the same conditions at which the reference picture, stored in memory, was taken.

According to some embodiments, the background reflects light. According to some embodiments, the background is smooth. According to some embodiments, the background is monocolor. According to further embodiments, the background is white. According to further embodiments, the background is a light color. According to further embodiments, the picture is taken using a flash. According to further embodiments, the picture is taken in direct sunlight or in the presence of a constant and strong light source natural or artificial. According to yet another embodiment, the pictures are taken using a flash against a background that reflects light. According to yet another embodiment, the pictures are taken using a flash against a white background. Under such conditions the high reflection of the light should cause the difference between the two pictures/areas in the same picture to be mainly attributed to the exposure of the chemochromic material to the analyte.

According to the invention, any appropriate type of chemochromic variable optical filter may be applied to the optical lens of the camera. Basically, the chemochromic variable optical filter must include a chemochromic material that changes optically when exposed to the detected analyte, and further, the chemochromic variable optical filter must be engineered with optical transparency or translucency, such that the screen shot probes the whole active volume/thickness of the variable optical element in such a way that the electromagnetic radiation passes through the variable optical element, operating by transmission, not reflection and/or refraction. It is noted that unless otherwise stated, any references to transparency or translucency herein are to understood to include both transparency and translucency.

According to the invention the optical change of the variable optical filter exposed to the analyte should be in the sensitivity range of the camera in the applied illumination spectrum, e.g., ambient light, flash. According to another embodiment, the optical change of the variable optical filter exposed to the analyte can be induced by any appropriate electromagnetic radiation, e.g., visible light, UV fluorescence, IR, thermoluminescence, chemoluminescence, bioluminescence, x-rays phosphorescence, electroluminescnece, fluorescent materials with long period of postluminescnce, etc. or any combination thereof.

According to some embodiments, the chemochromic variable optical filter, on which the chemochromic material is applied, includes a backing and an upper layer coated thereon, wherein the upper layer includes the chemochromic material. According to some embodiments, the backing is a transparent colorless polymer sheet. According to some embodiments, the backing is prepared from polyethylene (PE), polymethylmethacrylate (PMMA), polyethylene terephthalate (PET) or any other appropriate polymer.

According to some embodiments, the upper layer includes only the chemochromic material. According to further embodiments, the upper layer includes additional substances. According to such embodiments, the upper layer is designed so that when the analyte is introduced to the chemochromic variable optical filter it will have contact with the chemochromic material. According to further embodiments, the upper layer further includes a transparent or translucent substance. According to some embodiments, the substance is porous. According to some embodiments, the media is silica gel, polyacrylamide gel, sol gel, polyvinyl alcohol. According to some embodiments, the media includes a light dispersing material, so as to reduce the effect of the background of the photographed image as well as that of a flash, light, etc.

According to such embodiments, the chemochromic material is incorporated into the additional substances found in the upper layer by any appropriate means, such as a solution, suspension, dispersion or the like. According to some embodiments, the upper layer is deposited on the backing by any appropriate means, including laminating, spraying, coating or casting.

The chemochromic variable optical filter may be designed in any appropriate way so as to enable it to be applied to the optical lens of the camera. According to some embodiments, the chemochromic variable optical filter is a membrane, patch, label, window, diaphragm, film etc. According to some embodiments, the chemochromic variable optical filter includes any appropriate type of adhesive. According to some embodiments, the adhesive is found on the backing. According to some embodiments, the adhesive is located in an area on the chemochromic variable optical filter that does not cover the optical lens of the camera. According to some embodiments, the chemochromic variable optical filter is designed similarly to a Band-Aid®, such that the active part of the variable optical filter is placed over the optical lens and the inactive parts are stuck to regions around the lens by way of any appropriate adhesive. According to some embodiments, the adhesive is initially covered by a removable material, which is removed for applying the chemochromic variable optical filter to the camera. The thickness, amount and concentration of the chemochromic material depend on the specific type of the sample, the amount of analyte to be detected and the specific chemochromic material used. According to some embodiments, the thickness of the chemochromic layer is between 10-100 micron. According to some embodiments, the thickness of the chemochromic layer is between 10-20 micron. According to some embodiments, the thickness of the chemochromic layer is between 20-30 micron. According to some embodiments, the thickness of the chemochromic layer is between 30-40 micron. According to some embodiments, the thickness of the chemochromic layer is between 40-50 micron. According to some embodiments, the thickness of the chemochromic layer is between 50-60 micron. According to some embodiments, the thickness of the chemochromic layer is between 60-70 micron. According to some embodiments, the thickness of the chemochromic layer is between 70-80 micron. According to some embodiments, the thickness of the chemochromic layer is between 80-90 micron. According to some embodiments, the thickness of the chemochromic layer is between 90-100 micron. According to some embodiments, the thickness of the chemochromic layer is above 100 micron. According to some embodiments, the thickness of the chemochromic layer is between 100-200 micron.

According to some embodiments, the concentration of the chemochromic material is 10 nM-1M. According to some embodiments, the concentration of the chemochromic material is at least 10 nM. According to some embodiments, the concentration of the chemochromic material is not higher than 1M.

According to some embodiments, the sample is a gas. According to other embodiments the sample is a liquid volatilized by means of evaporation, aerosol formation or nebulization. According to another embodiment the sample is a gaseous suspension of solid particles obtained, for example, by thermal volatilization. According to further embodiments, the sample is a liquid, solid, gel, plasma, flame, cream and the like.

According to some embodiments, the chemochromic variable optical filter is exposed to the sample by exhaling breath, i.e., the detected analyte is a substance found in the breath of the user. The necessary amount of chemochromic material and the volume of gas, e.g., breath, or liquid, e.g., by drop or spray, are dependent on one another. According to some embodiments, the chemochromic variable optical filter is exposed to a single breath. According to further embodiments, the chemochromic variable optical filter is exposed to at least two breaths or to a certain volume which is determined by one skilled in the art.

According to some embodiments, the volume of the sample containing the analyte is predefined, such that a quantitative analysis of the amount of analyte may be performed. Such a quantitative analysis may include the use of means such as a calibrated volume balloon for gas or a pipette for liquids to ensure that an exact volume of the sample is measured. According to some embodiments, such a quantitative analysis may be used for medical means.

According to some embodiments, a calibration curve is prepared testing samples with a known amount of the analyte. Such a calibration curve may be stored for future use in determining the amount of the analyte in samples wherein the concentration of the analyte is unknown. In another embodiment a calibrated reference picture may be stored. According to some embodiments, a calibration curve may be prepared by measuring a fixed component in the sample, such as nitrogen (or any other inert gas) in breath. According to some embodiments, a calibration curve may be prepared for each individual using the system. An individual calibration curve may be prepared by averaging a multiple number of tests performed on that specific individual.

According to some embodiments, the chemochromic filter is in liquid form contained in a properly designed optically transparent cuvette. According to another embodiment, the chemochromic filter is a properly designed transparent mirochannel (microfluidic) chip filled with liquid or solid chemochromic solution or mixture.

According to some embodiments, the sample is a gas. According to some embodiments, the sample is a liquid. According to some embodiments, the sample is a solid.

According to other embodiments, the image analysis software provides a qualitative analysis. According to some embodiments, the image analysis software provides results relating to the presence or absence of the analyte according to a predefined threshold relating to the optical changes in the chemochromic material. According to further embodiments, the image analysis software provides a result that is positioned, graphically and/or numerically, on a range bar and/or in a range list, which includes several ranges relating to the amount or presence of the analyte. According to some embodiments the ranges include a “not identified” range, “low amount” range and “high amount” range, relating to the presence of the analyte in the tested sample (or any similarly noted ranges). According to further embodiments, the ranges include a “not identified” range and an “identified” range (or any similarly noted ranges).

According to some embodiments, the reaction of the chemochromic material is reversible, i.e., the chemochromic material returns to the optical state it was in before exposure to the analyte, within a certain period of time after exposure. According to some embodiments, when the chemochromic material is reversible, the chemochromic variable optical filter may be reused after a predetermined time, disregarding the prior use thereof. According to some embodiments, the chemochromic material is actively returned to its original optical state, e.g., by heating, mechanical vibration, ultrasound, chemical reaction, microwaves, and the like or any combination thereof. According to some embodiments, the chemochromic variable optical filter should be stored in inert conditions.

According to other embodiments, the reaction of the chemochromic material is irreversible. Such irreversible chemochromic materials may be used for measuring the accumulation of a certain analytes in multiple or long time exposures. According to some embodiments, irreversible chemochromic materials may be used to prepare a graph showing the amount, or relative amount, of the analyte, by comparing the reaction of the chemochromic material at preset time points. An example of such a measurement would be the use of the method of the present invention to monitor the amount of specific pollutants in any type of environment, e.g., home, work, public areas, outdoors, etc. A chemochromic variable optical filter would be applied to the optical lens of a camera, which would be set automatically or manually to take pictures, through the chemochromic variable optical filter, at predetermined times, possibly with a constant interval, though not necessarily. The comparison performed by the image analysis software between the different pictures will enable to prepare a graph demonstrating the amount of accumulated pollutant at every time point that a picture was taken, thus enabling the user to follow the pollutant concentration in the tested area as well as the accumulated effect thereof.

According to some embodiments, the chemochromic variable optical filter is designed to be disposable, i.e., for a one time use. According to further embodiments, the chemochromic variable optical filter is initially packaged in any type of a sealed impermeable pouch, envelope, compartment, etc., such that no exposure of the chemochromic material to the analyte is possible before the package is opened. Accordingly, the invention is further directed to a kit comprising a chemochromic variable optical filter that may be sealed in a package impermeable to the analyte. According to some embodiments, once the package is opened, the chemochromic variable optical filter is applied to the optical lens of the camera and is used within a short time, such that no exposure of the chemochromic material to the analyte is possible before the first picture is taken. According to some embodiments, the kit, the chemochromic variable optical filter as packaged in the kit, or both the kit and the chemochromic optical filter, as packaged in the kit, are impermeable to the analyte. According to some embodiments, the kit further comprises white cloth, paper or any other appropriate material that the user may use as a background. According to further embodiments, the kit comprises a user instruction leaflet. According to some embodiments, the kit comprises a calibration scale, relating to the concentration of the analyte. According to some embodiments, the calibration scale is provided digitally by the image analysis software or any accompanying software. According to some embodiments, the kit comprises a calibrated volume balloon for collecting a specific, predetermined volume of the sample and then exposing the chemochromic material to that specific volume. According to some embodiments, the kit comprises an applicator or means for applying the chemochromic variable optical filter to the optical lens of a camera or the near or far proximity thereof.

According to some embodiments, the software includes a reference picture taken through a chemochromic variable optical filter that was not exposed to the analyte, under certain lighting conditions and against a specific background, e.g., one provided with a kit. According to another embodiment the software includes a reference picture taken through a chemochromic variable optical filter that was exposed to a calibrated volume and concentration of the analyte, under certain lighting conditions and against a specific background, e.g., one provided with a kit.

According to such embodiments, it is possible to take only one picture after the chemochromic variable optical filter is exposed to the analyte, which is compared by the image analysis software to the reference picture. According to further embodiments, the reference picture may be provided together with a kit in by any digital means, such as flash memory. According to further embodiments, the reference picture may be downloaded by the user from the internet.

According to some embodiments, the chemochromic variable optical filter is designed so as to detect one type of analyte. The detection of one type of analyte may be performed when the chemochromic variable optical filter is placed on the optical lens of the camera, in the near proximity thereof, i.e., outside the depth of field of the optical lens of the camera, or in the far proximity thereof, i.e., within the depth of field of the optical lens of the camera.

According to other embodiments, the chemochromic variable optical filter is applied (positioned) in far proximity relating to the optical lens of the camera, i.e., within the depth of field of the camera, resulting in a highly defined image of the variable optical filter. According to such an embodiment, the frame taken after the exposure to the analyte may be compared with a separate reference; however, it is possible to use certain parts of that frame as a reference, which are compared with other parts of the same frame. Thus, description herein relating to the comparison between different parts of the same frame should be understood to relate to embodiments where the variable optical filter is positioned within the depth of field of the camera. Further, unless specifically stated otherwise or unless physically inconceivable, any language relating to placing the variable optical filter (or variable optical element) on the optical lens of the camera should be understood to include also placing the variable optical element in the near proximity of the optical lens, as well as in the far proximity of the optical lens, i.e., including application of the variable optical element both within and outside the depth of field of the camera.

According to embodiments where a high definition image is obtained, the reference may relate to any digital media that includes data/parameters regarding the part of the chemochromic material on the variable optical filter that was not exposed to the analyte or an area in the image which does not contain the chemochromic material.

According to further embodiments, in far proximity mode the chemochromic variable optical filter is designed so as to detect a multiple number of analytes. According to some embodiments, the chemochromic variable optical filter includes a multiple number of chemochromic materials in predefined areas, wherein each chemochromic material detects a different analyte, such that a multiple number of analytes may be detected simultaneously under the condition that no spectral overlap occurs.

According to further embodiments, the chemochromic variable optical filter is prepared such that the concentration of the chemochromic material is placed thereon in a predefined concentration gradient.

According to the invention, each chemochromic variable optical filter is designed to detect a certain type or types of analyte, set according to the desired use of the method of the invention. Types of analytes include volatile sulfur compounds, such as H2S or mercaptan, for measuring bad breath, alcohol in breath or ethyl glucuronide in urine, for measuring recent alcohol consumption, acetone in breath or urine, indicating glucose blood levels and fat burning levels, particularly beneficial for diabetics, determination of traces of gluten in food samples, hydrogen, methane, carbon monoxide, carbon dioxide, benzene, any type of pollutant and various organic compounds, such as formaldehyde, benzoyl peroxide and others.

The chemochromic materials found in the chemochromic variable optical filter are chosen according to the designation of the specific chemochromic variable optical filter manufactured, i.e., according to the type of analyte/s to be detected. For example, volatile sulfur compounds, such as H2S and mercaptane, may be detected by potassium thiocyanate and ammonium molybdate, which change from colorless to red upon exposure to such compounds, lead acetate, which changes from colorless to black, 5′5-dithiobis(2-nitrobenzoic acid), which changes from white to yellow, Neocuproine-Cu(II) and/or CuSO4. Such compounds are known to detect about 0.1-1.0 ppm volatile sulfur compounds in gas, e.g., in breath. Sulfur dioxide may be detected using dichloro-bis(diphenylphosphino) and/or methane dipalladium(I), possibly immobilized in a PVC membrane plasticized with o-nitrophenyloctylether. Ethanol may be detected by polydiacetylene/ZnO nanocomposites, acidic solutions of chromium(VI) salt, acidic chromate supported on a silica gel and/or Dye CR-546. Such compounds are known to detect about 10-100 pg ethanol in 100 ml gas, e.g., breath. Acetone may be detected by iodine in an acidic environment in a range of about 0.3-1.0 ppm. Ammonia may be detected by bromophenol blue (BMP) or bromocresol purple. Carbon monoxide may be detected by molybdenum, tungsten or vanadium color forming agents, palladium, ruthenium or osmium catalysts and reversing agents, such as iron, chromium or cerium, as detailed in U.S. Pat. No. 5,405,583. Hydrogen may be detected by palladium based compounds, titanium dioxide, vanadium oxide, tungsten oxide, molybdenum oxide, yttrium oxide, platinum containing compounds, such as platinum oxides, hydroxides and hydrated oxides and any combination thereof. Nitrogen dioxide may be detected by metallo-porphyrines.

Color pH indicators are widely used and can be utilized, according to some embodiments, by the method of invention in order to measure the pH of a sample. Thus, the invention includes measurements of presence, as well as amounts, of acids and bases in a given sample.

According to some embodiments, biomolecules, bacteria and viruses can be detected by vesicle based chromatic filters (Jelinek & Kolusheva, Top. Curr. Chem. DOI 10.1007/1282007, Springer Verlag Berlin, Heidelberg 2007). Colorimetric sensing of Nitro aromatic explosives has been demonstrated and can be utilized according to some embodiments in the method of invention (see, e.g., Yingxin Ma et al, Anal. Chem. 2012, 84(19) pp 8415-8421). Sensitive Colorimetric Detection of Warfare Gases by Polydiacetylenes has been demonstrated, e.g., by Jiseok Lee et al., Advanced Functional Materials, Volume 22, Issue 8, pages 1632-1638, April 24, and can be utilized, according to some embodiments, in the method of invention.

Some embodiments are directed to a designated sensor embedded in any type of appropriate device, including a digital camera, a smartphone, PC, tablet and the like, wherein the embedded designated sensor includes a multipixel photo electronic sensor coupled to a variable optical element. According to some embodiments, the variable optical element may be reset and reused a number of times, as detailed above. According to some embodiments, means for resetting the variable optical element are attached to or embedded in the same device the designated sensor is embedded into.

Embodiments of the invention include any modifications necessary in the device, which enable it to be used according to embodiments of the invention. According to some embodiments, the device includes (or is attached to) means for resetting the variable optical element, an opening for introducing the sample, such that it comes in contact with the variable optical element, means for radiating/illuminating the variable optical element from within the device, means for allowing external radiation/light to enter the device in order to illuminate/radiate the variable optical element and the like. The opening for introducing the sample may be of any appropriate shape or size, such as a conical opening. The opening may be equipped with any type of valve, including a unidirectional valve. According to some embodiments, the opening for introducing the sample has an opened and closed configuration, wherein the configuration may be changed manually, automatically, or by any appropriate means or drive mechanism. According to some embodiments, the sample can be introduced through the opening by any appropriate means, including breath, gas balloon, spray, droplets, a pipette, a syringe, a designated applicator and the like. According to some embodiments, the opening is directed specifically to the variable optical element embedded in the device and therefore, does not harm the sealing thereof, such that the other components of the device are not exposed to the sample or to any other undesired external materials. According to some embodiments, the closed configuration of the opening seals the device, such that no external material may enter the device when the opening in closed.

According to some embodiments, the multipixel photoelectric sensor is a Complementary Metal Oxide Semiconductor (CMOS), charge coupled device (CCD), a photo multiplayer, or a Foveon image sensor. It is noted that, unless specifically mentioned otherwise, any reference to one type of sensor herein, e.g., CMOS, can be replaced with any other appropriate sensor. Some embodiments are directed to a stand-alone photo multi-pixel electronic image sensor having image process and display capabilities. According to some embodiments, the multi-pixel electronic image sensor is included in a stand-alone digital camera that includes image process and display capabilities. According to some embodiments, the multi-pixel electronic image sensor is included in a stand-alone device, such as a smartphone, PC, tablet and the like that includes image process and display capabilities.

According to some embodiments, the variable optical element is illuminated with white light, possibly with indium titanium oxide (ITO). According to some embodiments, the variable optical element is a filter, prism, mirror, resonator or a Fresnel optics element.

According to some embodiments, the sensor includes a plurality of sensors coupled to a plurality of variable optical elements, such that a multiple number of samples, possibly containing different analytes, may be tested. According to some embodiments, the plurality of sensors/variable optical elements may be in an array formation, used consecutively. The array may be linear, rectangular, square, circular, or in any appropriate shape. The sensors/elements in the array may be used consecutively, wherein each new sensor/element is exposed to each new sample. According to some embodiments, the array is manually driven to expose each sensor/element, in turn, to the sample. According to some embodiments, the array is coupled to a driving mechanism, which drives the array so as to expose each sensor/element, in turn, to the sample.

According to some embodiments, the plurality of sensors/variable optical elements includes sensors/variable optical elements that may detect any number of analytes. According to some embodiments, each sensor/element in the array is prepared to detect a different type of analyte. According to other embodiments, any number of sensors/elements in the array may be designed to detect the same type of analyte. According to some embodiments, any one sensor/element in the array may be designed, in itself, to detect more than one analyte.

According to some embodiments, once the entire array or sensor/variable optical elements is used, the array is reset to its original optical mode, using any of the means detailed above. According to further embodiments, each one of the sensors/variable optical elements may be reset once used on its own, not depending on the state of use of any of the other sensors/variable optical elements in the array.

As noted above, the camera may either be part of a device having image analysis software or may be connected to such a device by any means, such as designated cables or manual operation using, e.g., flash memory to transfer the screen shot from the camera to a device comprising image analysis software. According to some embodiments the camera is connected to a device having image analysis software only after the pictures were taken and stored in memory. According to further embodiments, the pictures are sent, e.g., by internet or Bluetooth, to a device having image analysis software.

The image analysis software should be able to perform spectral analysis, prepare a color histogram, and be able to detect a change in the optical properties of the chemochromic material, e.g., color, transparency, optical density, etc. Any appropriate image analysis software may be used including algorithms chosen from the following list:
Pearson Correlation
Histogram comparison methods
   Correlation
   Bhattacharyya distance
   Chi-squared Histogram matching distance
   Earth Mover's Distance (EMD)
   Intersection
   Euclidean distance
   Manhattan Distance
Phase correlation
Correlation based similarity measures
   Sum of Absolute Differences (SAD)
   Zero-mean Sum of Absolute Differences (ZSAD)
   Locally scaled Sum of Absolute Differences (LSAD)
   Sum of Squared Differences (SSD)
   Zero-mean Sum of Squared Differences (ZSSD)
   Locally scaled Sum of Squared Differences (LSSD)
   Normalized Cross Correlation (NCC)
   Zero-mean Normalized Cross Correlation (ZNCC)
   Sum of Hamming Distances (SHD)
      Many commercial or open source image processing programs are available, such as Xlstat by Addinsoft and ENVI5 by EXELIS.

According to some embodiments, chemochromic variable optical filters comprising chemochromic material were prepared, wherein the chemochromic material was incorporated into a layer of an inert material, such as polyvinyl alcohol (PVA) cast onto a transparent bakcing, prepared, e.g., from polyethylene terephthalate (PET). In order to prepare a calibration curve, each filter may be applied, in turn, to the optical lens of a digital camera. An initial picture may be taken prior to the exposure of the filter to the analyte, thereby preparing a reference picture. The variable optical filter may then be contacted with a certain concentration of the analyte, wherein each variable optical filter in turn may be contacted with a different concentration of the analyte found in a sample. A second picture may be taken after the exposure of each variable optical filter to the sample. The initial reference picture may then be compared to the second picture using image analysis software, thus measuring the visual difference caused by the exposure of the chemochromic material to the analyte. Since the above tests may be performed using known concentrations of the analyte, the results may be used to prepare calibration curve relating to that analyte. Such calibration curves may be used to determine the amount of the analyte in samples comprising an unknown concentration thereof.

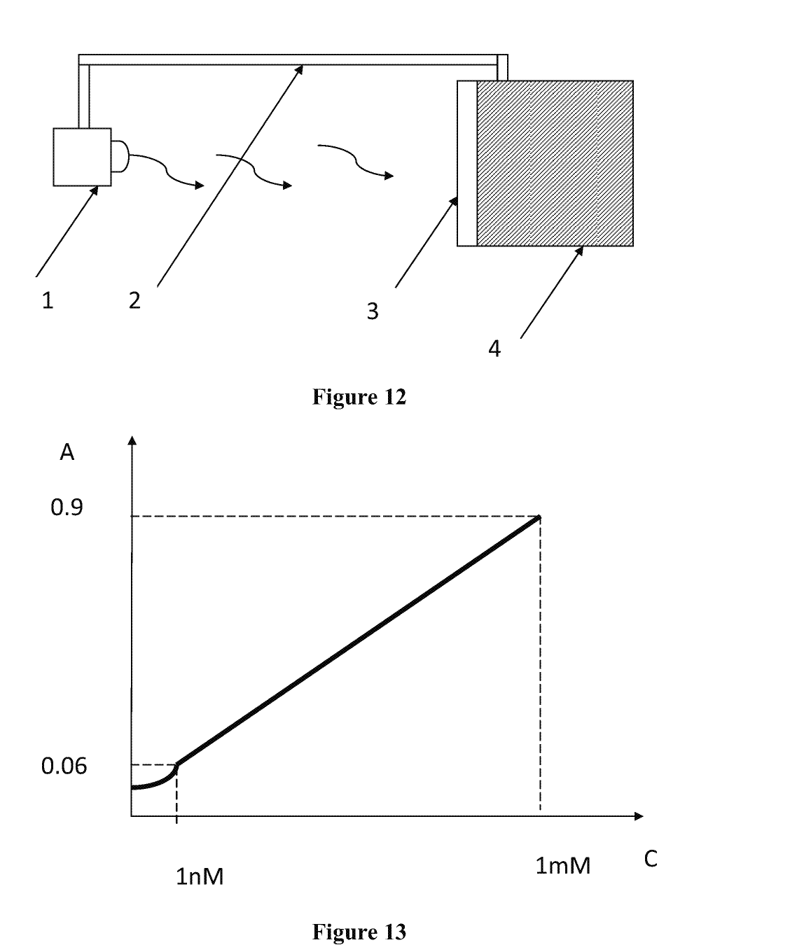

Reference is now made to FIG. 12, presenting an embodiment of the invention according to which UV source (1) is attached by radiation source holder (2) to digital camera (4). Variable optical element (3) is applied to the lens (not shown) of digital camera (4), such that the screen shot is taken outside the depth of field of digital camera (4). The use of such an embodiment is beneficial, e.g., as detailed in Example 8, for the detection of DNA, where the UV source is used for DNA fluorescence excitation.

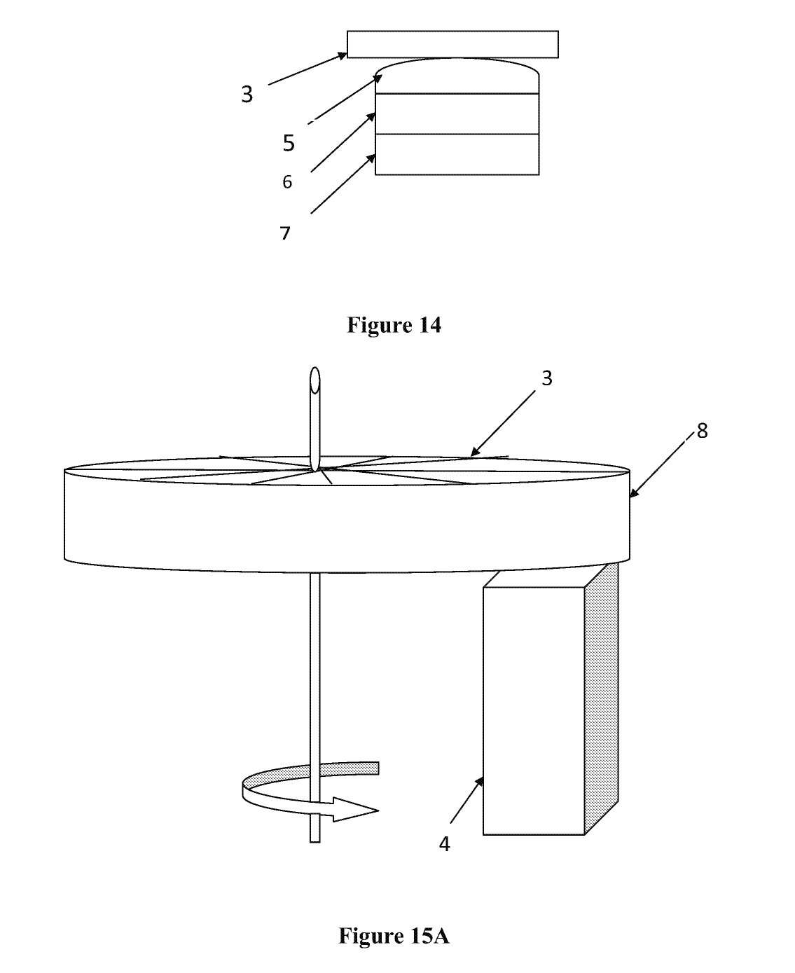

Reference is now made to FIG. 14, which presents a variable optical element (3) applied to the lens (5) of a digital camera, such that the screen shot is taken outside the depth of field of the camera. Once the screen shot is taken through lens (5) and variable optical element (3) applied thereto, the digital data acquired is transferred to a complementary metal-oxide-semiconductor (CMOS) sensor (possibly a Foveon® image sensor) or a charge-coupled device (CCD) (6) attached to an analog digital converter (ADC) (7) for processing the screen shot.

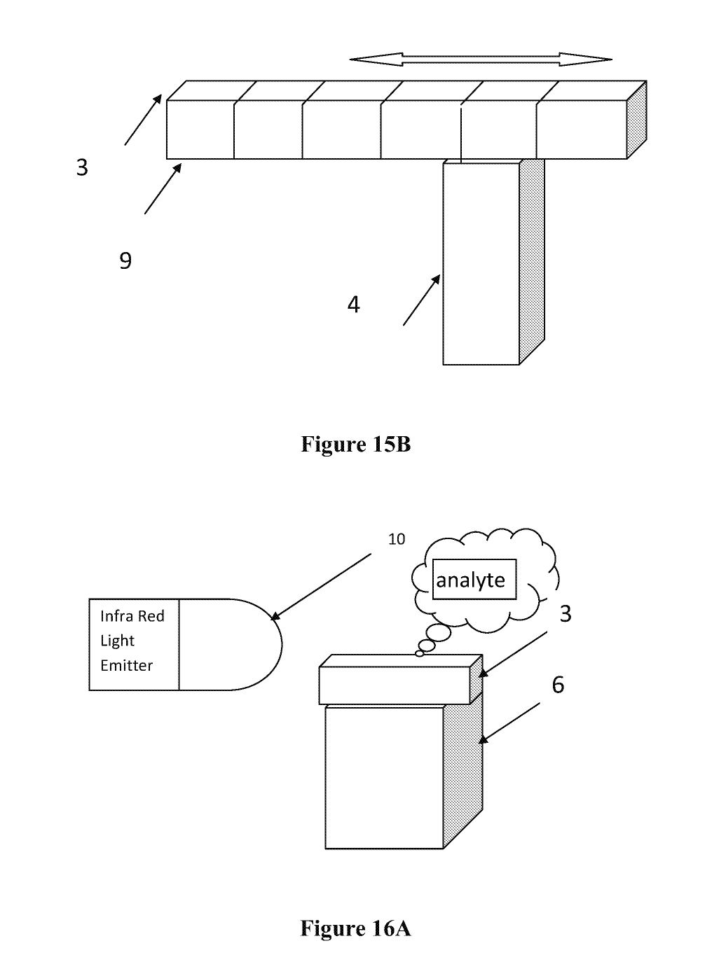

Reference is now made to FIG. 15A, presenting a circular array (8) of variable optical elements (3) and to FIG. 15B, presenting a rectangular array (9) of variable optical elements (3). Each variable optical element (3) is exposed to a sample and placed in front of digital camera (4) in turn. As detailed above, two screen shots may be taken through each variable optical element (3), one before and one after exposure to the sample, such that the screen shot taken before exposure is a reference screen shot, to which the second screen shot may be compared. According to other embodiments, one screen shot may be taken through each variable optical element after exposure to the sample, which is then compared to a reference screen shot obtained from any appropriate source.

When arrays, such as arrays (8) or (9) are used, any number of variable optical elements (3) included in the array may be designed to detect different analytes. The variable optical elements may then be exposed to a sample possibly containing more than one analyte or to a number of samples, wherein each variable optical element (3) may be exposed to a different sample. In order to expose only the desired variable optical elements to a sample, any number of variable optical elements in the array may be masked (fully or partially) and unmasked according to the use thereof. According to some embodiments, any number of variable optical elements (3) in an array, such as arrays (8) or (9) may be designed to detect the same analyte, possibly for the preparation of a calibration curve or for performing a quantitative measurement relating to the amount of a certain analyte in different samples.

Since the use of each variable optical element (3) requires that element to be placed in front of digital camera (4), the array is designed so that the position of each variable optical element (3) in respect to digital camera (4) may be set and changed according to the desired use. According to some embodiments, the position of each variable optical element is changed manually. According to further embodiments, the position of each variable optical element is changed mechanically. As shown in FIG. 15A, since array (8) is circular, rotational motion is used in order to change the position of the variable optical elements (3) in relation to digital camera (4). As shown in FIG. 15B, since array (9) is rectangular, linear motion is used in order to change the position of the variable optical elements (3) in relation to digital camera (4).

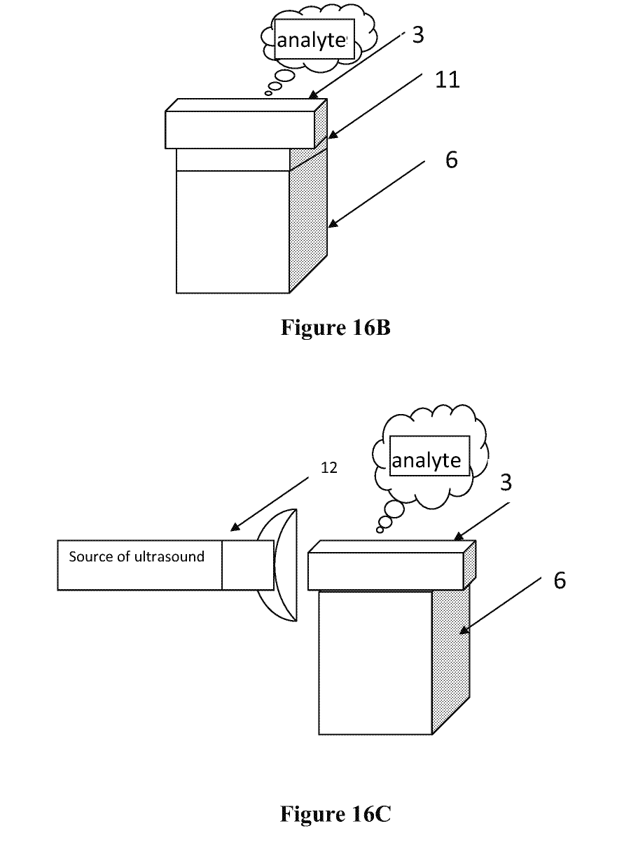

Reference is now made to FIG. 16A, presenting a variable optical element (3) that is coupled to a CMOS chip (6). Variable optical element (3) is exposed to an analyte, which changes the optical state of the chemochromic material included in the variable optical element (3). After exposure (and measurement of the chemochromic changes occurring as a result of the exposure) the variable optical element (3) is returned to its original optical state by IR radiation source (10). It should be understood that, as detailed herein, the components shown in FIG. 16A may be embedded in a digital camera (not shown).

Reference is now made to FIG. 16B, presenting a variable optical element (3) that is coupled to a CMOS chip (6). Variable optical element (3) is exposed to an analyte, which changes the optical state of the chemochromic material included in the variable optical element (3). After exposure (and measurement of the chemochromic changes occurring as a result of the exposure) the variable optical element (3) is returned to its original optical state by heating element (11). It should be understood that, as detailed herein, the components shown in FIG. 16B may be embedded in a digital camera (not shown).

Reference is now made to FIG. 16C, presenting a variable optical element (3) that is coupled to a CMOS chip (6). Variable optical element (3) is exposed to an analyte, which changes the optical state of the chemochromic material included in the variable optical element (3). After exposure (and measurement of the chemochromic changes occurring as a result of the exposure) the variable optical element (3) is returned to its original optical state by ultrasound source (12). It should be understood that, as detailed herein, the components shown in FIG. 16C may be embedded in a digital camera (not shown).

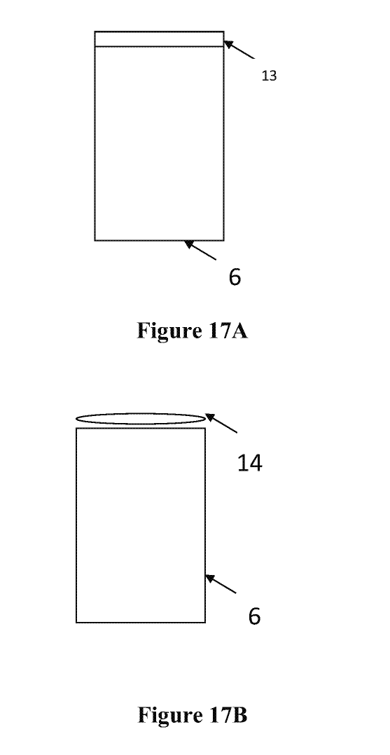

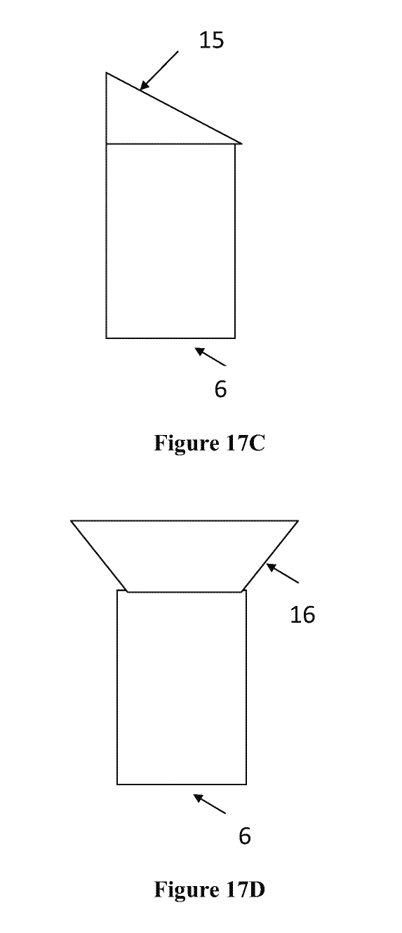

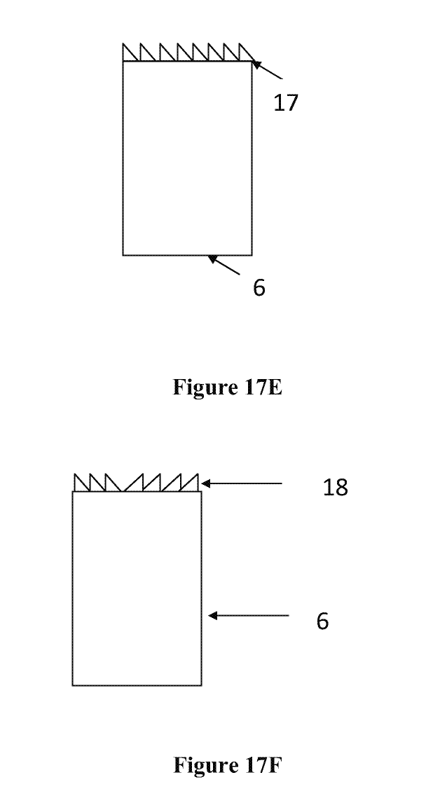

Reference is now made to FIG. 17A presenting a variable optical element that is a filter (13) coupled to CMOS chip (6). FIG. 17B presents a variable optical element that is a chemochromic lens (14) coupled to a CMOS chip (6). FIG. 17C presents a variable optical element that is a chemochromic prism (15) coupled to a CMOS chip (6). FIG. 17D presents a variable optical element that is a chemochromic mirror (16) coupled to a CMOS chip (6). FIGS. 17E and 17F present variable optical elements that are chemochromic Frensel optical elements (17) and (18) CMOS chips (6). It should be understood that, as detailed herein, the components shown in FIGS. 17A-17F may be embedded in a digital camera (not shown).

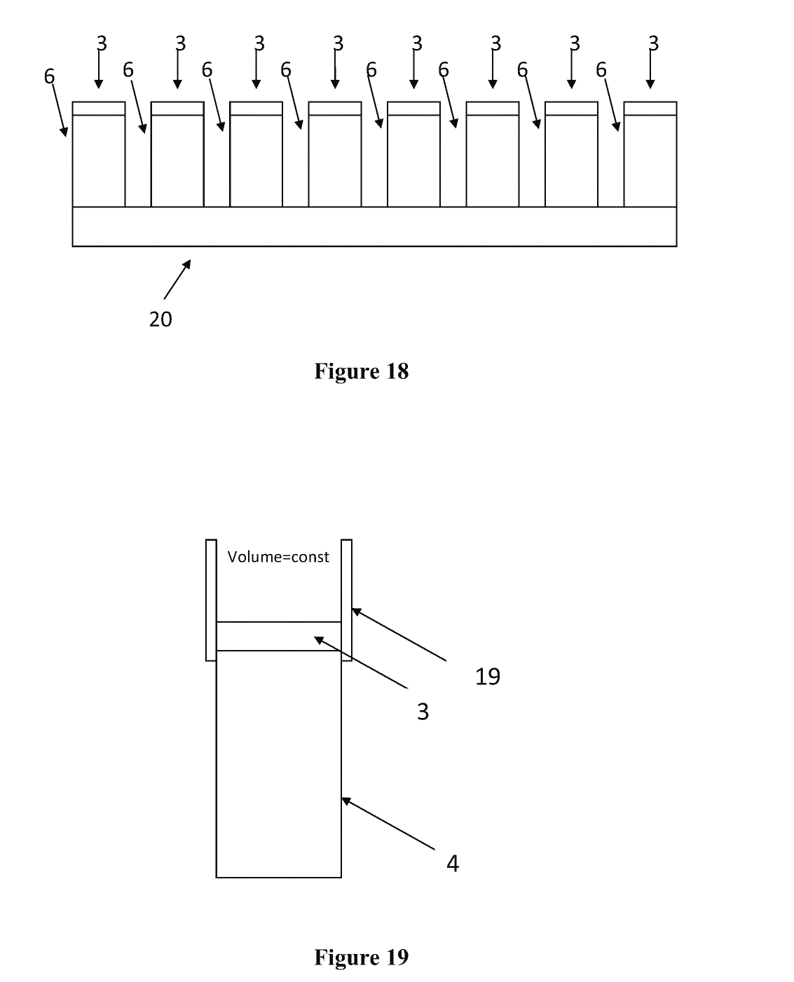

Reference is now made to FIG. 18, presenting an array of CMOS chips (6), each coupled to a variable optical element (3), wherein the chips are attached to base (20) and may be embedded in a digital camera (not shown). The CMOS chips may be substituted with any other appropriate element (CCD, Foveon image sensor etc.).

Reference is now made to FIG. 19, presenting an embodiment of a constant volume sampling reservoir (19) that is placed on (or somehow attached) to variable optical element (3), which is placed on digital camera (4). Such a volume sampling reservoir (19) may be used in order to expose variable optical element (3) to a constant volume of a sample (not shown).

### Example 1

### Mercaptan Detection

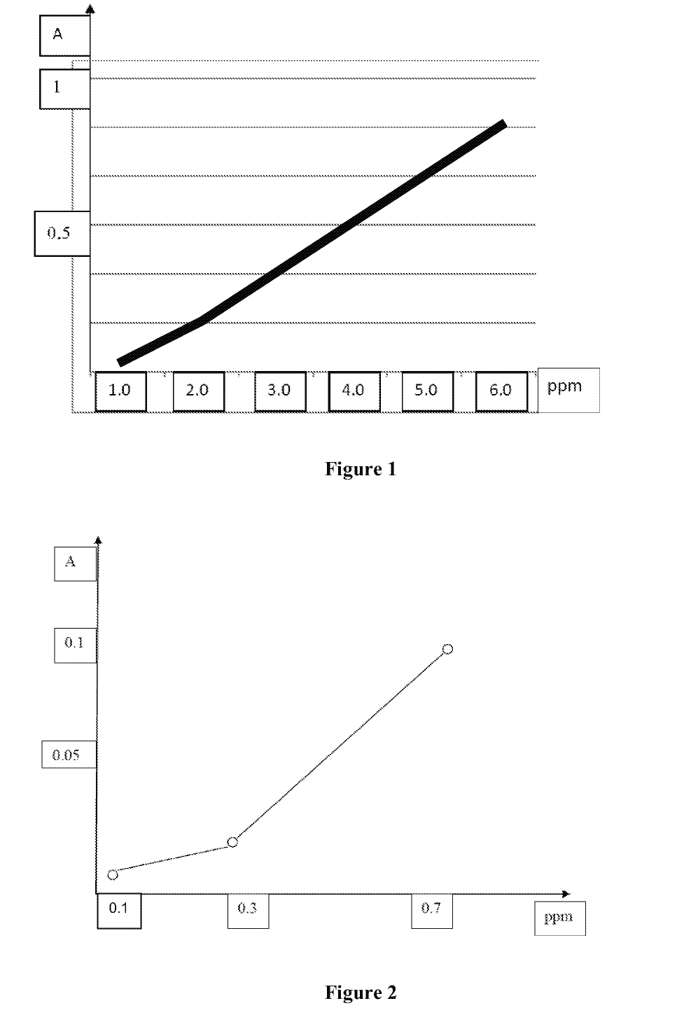

Chemochromic variable optical filters comprising the chemochromic material CuSO4 were prepared so that the active region of each filter had 1.5 mg/cm2 of CuSO4 incorporated into a 70 micron layer of polyvinyl alcohol (PVA) cast onto a transparent polyethylene terephthalate (PET) backing. Each filter was applied, in turn, to the optical lens of a digital camera. An initial picture was taken prior to the exposure of the filter to mercaptan (reference picture). The variable optical filter was then exposed to a certain concentration of mercaptan, wherein each variable optical filter in turn was exposed to a different concentration of mercaptan in a sample of 100 ml of air. A second picture was taken after the exposure of the variable optical filter to the sample. The initial reference picture was compared to the second picture using image analysis software, thus measuring the visual difference caused by the exposure of the chemochromic material to the mercaptan. Since the above tests were performed using known concentrations of mercaptan, the results were used to prepare the calibration curves shown in FIGS. 1 and 2. FIGS. 1 and 2 present the results of the above tests in ranges of 1-6 ppm mercaptan and 0-1 ppm mercaptan respectively. The Y axis represents the relative optical absorption in the blue to yellow spectral change. FIG. 1 presents sample tests of 1, 2, 3, 4, 5 and 6 ppm mercaptan and FIG. 2 presents sample tests of 0.1, 0.3 and 0.7 ppm mercaptan.

Such calibration curves may be used to determine the amount of mercaptan in samples comprising an unknown concentration thereof.

### Example 2

### Alcohol Detection

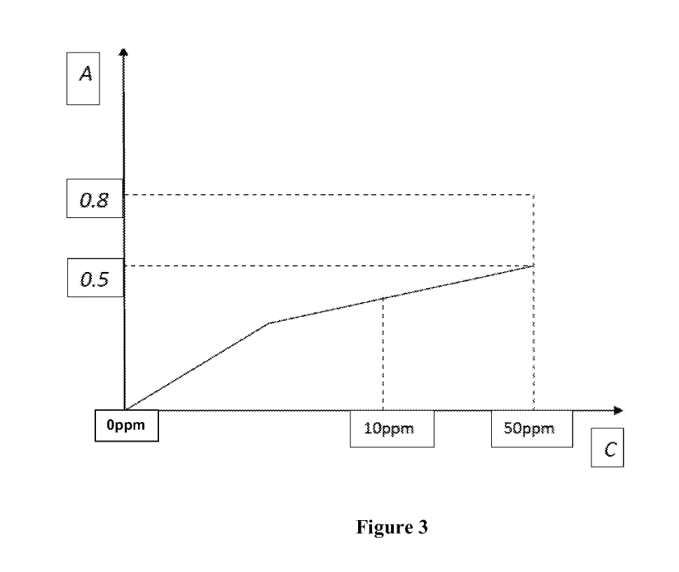

Chemochromic variable optical filters were prepared by depositing an active coating comprising 30% polyvinyl alcohol, 0.1% CR-546 (N,N-dioctylamino-4′-trifluoroacetyl-2′-nitroazobenzene) Fluka Cat. No 08709 (Selectophore™) and 69.9% water on a polyethylene phthalate inert backing having a thickness of 100 microns. Each variable optical filter was applied, in turn, to the optical lens of a digital camera. An initial picture was taken prior to the exposure of the variable optical filter to alcohol. The variable optical filter was then exposed to a certain concentration of alcohol, wherein each variable optical filter in turn was exposed to a different concentration of alcohol in a sample of 100 ml air. A second picture was taken after the exposure of the variable optical filter to the sample. The initial picture was compared to the second picture using image analysis software, thus measuring the visual difference caused by the exposure of the chemochromic material to the alcohol. Since the above tests were performed using known concentrations of alcohol, the results were used to prepare the calibration curve shown in FIG. 3. FIG. 3 presents the results of the relative optical absorption resulting from the transition from blue to rose due to alcohol concentrations in the range of 0-50 ppm. Such a calibration curve may be used to determine the amount of alcohol in samples comprising an unknown concentration thereof.

### Example 3

### Protein Detection

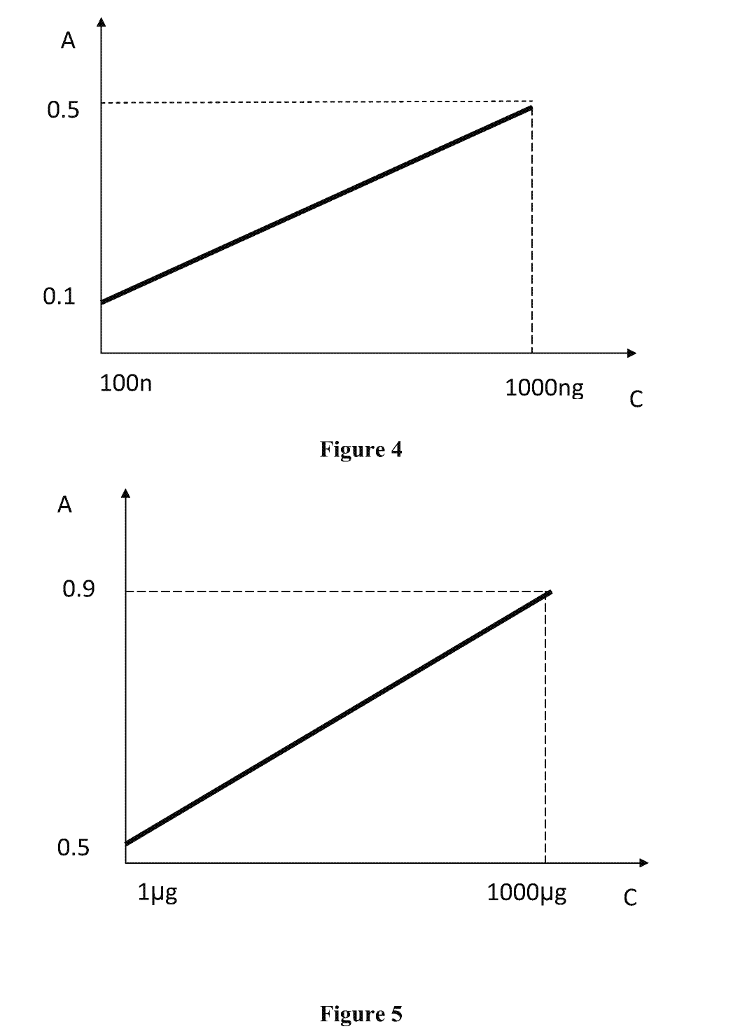

Chemochromic variable optical elements comprising the chemochromic material Coomassie Brilliant Blue G-250 were prepared so that the active region of each filter had 0.5 mg/cm2 of Coomassie incorporated into a 50 micron layer of polyvinyl alcohol (PVA) cast onto a transparent polyethylene terephthalate (PET) backing. Each filter was applied, in turn, to the optical lens of a digital camera. An initial picture was taken prior to the exposure of the filter to the bovine serum albumin (BSA) protein water based solution (reference picture). The variable optical filter was then exposed to a certain concentration of BSA, wherein each variable optical filter in turn was exposed to a different concentration of BSA in a sample of 5 μL that was placed, in liquid form, on the variable optical filter. A second picture was taken after the exposure of the variable optical filter to the sample. The initial picture was compared to the second picture using image analysis software, thus measuring the visual difference caused by the exposure of the chemochromic material to the protein (BSA). Since the above tests were performed using known amounts of BSA, the results were used to prepare the calibration curves shown in FIGS. 4 and 5. FIGS. 4 and 5 present the results of the above tests in ranges of 100-1000 ng BSA and 1 μg-1 mg BSA respectively. The Y axis represents the relative optical absorption in the blue to yellow spectral change. FIG. 4 presents sample tests of 100, 200, 300, 400, 500 and 600 ng BSA and FIG. 5 presents sample tests of 10 m, 100 m, 1000 m BSA.

Such calibration curves may be used to determine the amount of protein (BSA) in samples comprising an unknown amount thereof.

### Example 4

### Acetone Detection

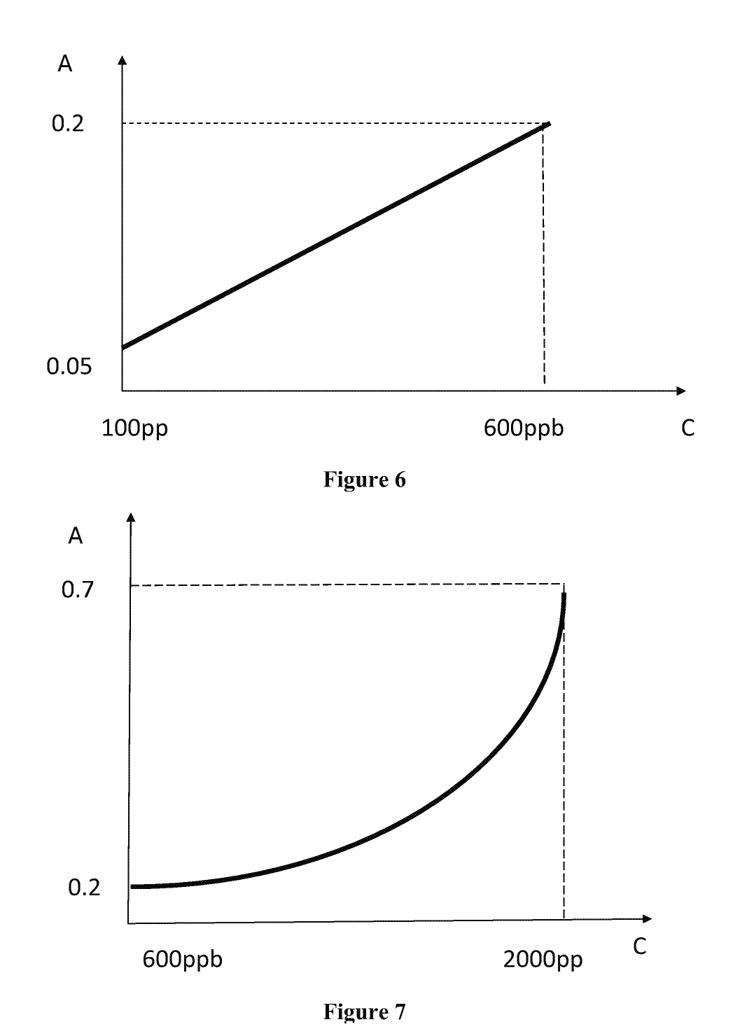

Chemochromic variable optical filters comprising the chemochromic material Sodium Nitroprusside combined with NaOH were prepared so that the active region of each filter had 0.7 mg/cm2 of sodium Nitroprusside and 0.01 mg/cm2 of NaOH incorporated into a 70 micron layer of polyvinyl alcohol (PVA) cast onto a transparent polyethyleneterephthalate (PET) backing. Each filter was applied, in turn, to the optical lens of a digital camera. An initial picture was taken prior to the exposure of the filter to acetone vapors (reference picture). The variable optical filter was then exposed to a certain concentration of acetone, wherein each variable optical filter in turn was exposed to a different concentration of acetone in a sample of 300 mL. A second picture was taken after the exposure of the variable optical filter to the sample. The initial picture was compared to the second picture using image analysis software, thus measuring the visual difference caused by the exposure of the chemochromic material to the acetone. Since the above tests were performed using known concentrations of acetone, the results were used to prepare the calibration curves shown in FIGS. 6 and 7. FIGS. 6 and 7 present the results of the above tests in ranges of 100-2000 ppb acetone, respectively. The Y axis represents the relative optical absorption in the blue to yellow spectral change. FIG. 6 presents sample tests of 100, 200, 300, 400, 500 and 600 ppb acetone FIG. 7 presents sample tests of 100-2000 ppb acetone.

Such calibration curves may be used to determine the amount of BSA in samples comprising an unknown concentration thereof

### Example 5

### pH Detection

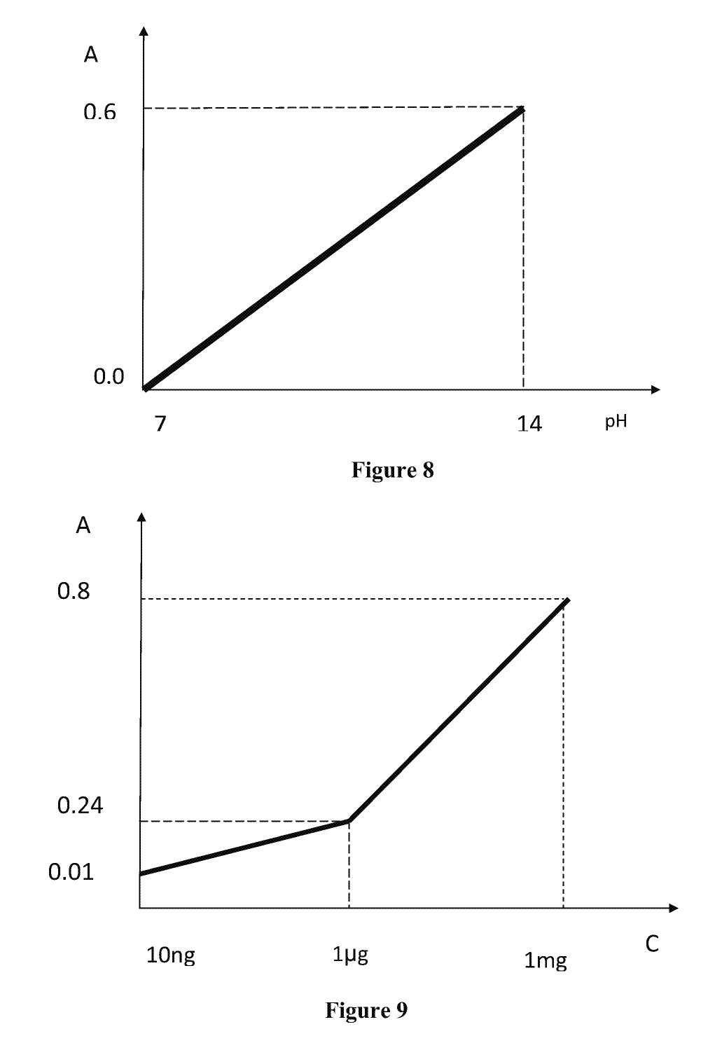

Chemochromic variable optical filters comprising the chemochromic material phenolphthalein were prepared so that the active region of each filter had 0.7 mg/cm2 of phenolphthalein incorporated into a 70 micron layer of polyvinyl alcohol (PVA) cast onto a transparent polyethyleneterephthalate (PET) backing. Each filter was applied, in turn, to the optical lens of a digital camera. An initial picture was taken prior to the exposure of the filter to pH water based solutions (reference picture). The variable optical filter was then exposed to a certain pH wherein each variable optical filter in turn was exposed to a different concentration of NaOH in a sample of 1 μL placed on the filter in liquid form. A second picture was taken after the exposure of the variable optical filter to the sample. The initial picture was compared to the second picture using image analysis software, thus measuring the visual difference caused by the exposure of the chemochromic material to the water based solution of NaOH. Since the above tests were performed using known concentrations of the NaOH base, the results were used to prepare the calibration curve shown in FIG. 8. FIG. 8 presents the results of the above tests in ranges of 7<pH<14. The Y axis represents the relative optical absorption in the colorless to red spectral change.

Such calibration curves may be used to determine the pH in samples comprising an unknown pH.

### Example 6

### Free Chlorine Detection

Chemochromic variable optical filters comprising the chemochromic material DPD (N,N-diethyl-p-phenylene-diamine) were prepared so that the active region of each filter had 0.1 mg/cm2 of DPD incorporated into a 20 micron layer of polyvinyl alcohol (PVA) cast onto a transparent polyethylene terephthalate (PET) backing. Each filter was applied, in turn, to the optical lens of a digital camera. An initial picture was taken prior to the exposure of the filter to a chlorine water based solution (reference picture). The variable optical filter was then exposed to a certain concentration of chlorine, wherein each variable optical filter in turn was exposed to a different concentration of chlorine in a sample of 1 μL, placed on the filter in liquid form. A second picture was taken after the exposure of the variable optical filter to the sample. The initial picture was compared to the second picture using image analysis software, thus measuring the visual difference caused by the exposure of the chemochromic material to the chlorine. Since the above tests were performed using known concentrations of free chlorine, the results were used to prepare the calibration curves shown in FIG. 9. FIG. 9 present the results of the above tests in ranges of 10-1000 ng chlorine and 1 μg-1 mg chlorine. The Y axis represents the relative optical absorption in the colorless to red spectral change.

Such calibration curves may be used to determine the amount of chlorine in samples comprising an unknown concentration thereof.

### Example 7

### Aliphatic Amines Detection

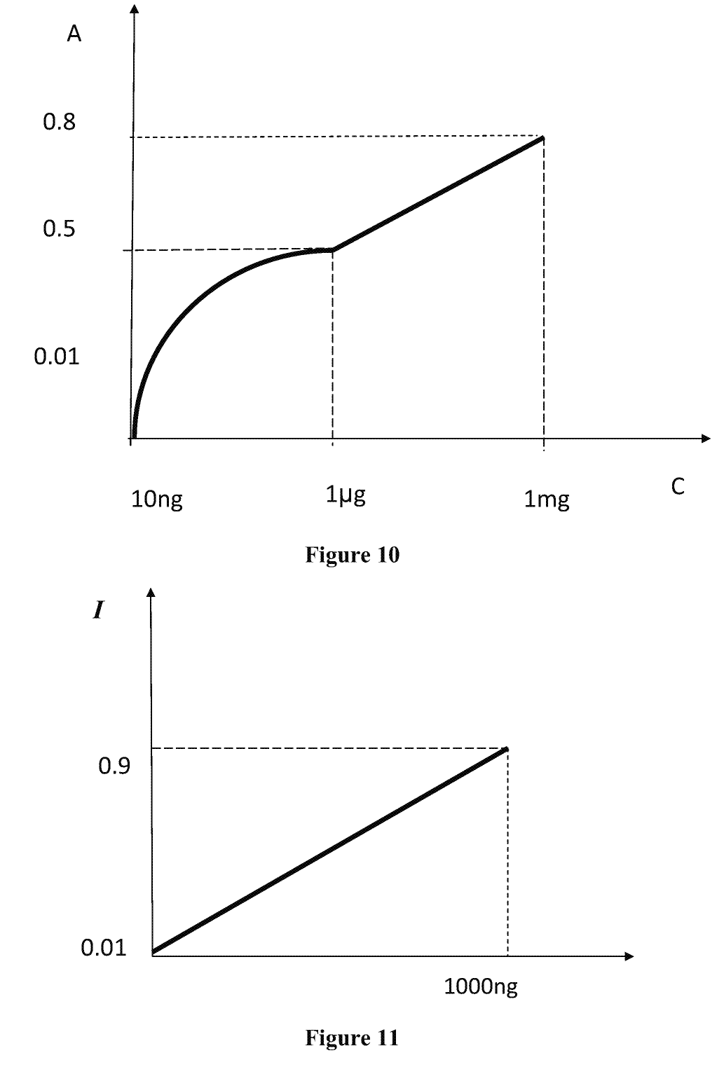

Chemochromic variable optical filters comprising the chemochromic material 1-chloro-2:4-dinitrobenzene (CDNB) were prepared so that the active region of each filter had 0.2 mg/cm2 of CDNB incorporated into a 50 micron layer of polyvinyl alcohol (PVA) cast onto a transparent polyethylene terephthalate (PET) backing. Each sensor was applied, in turn, to the optical lens of a digital camera. An initial picture was taken prior to the exposure of the filter to an aliphatic amine (AA) water based solution (reference picture). The variable optical filter was then exposed to a certain concentration of AA, wherein each variable optical filter in turn was exposed to a different concentration of AA in a sample of 3 μL, placed on the filter in liquid form. A second picture was taken after the exposure of the variable optical filter to the sample. The initial picture was compared to the second picture using image analysis software, thus measuring the visual difference caused by the exposure of the chemochromic material to the AA. Since the above tests were performed using known concentrations of AA, the results were used to prepare the calibration curves shown in FIG. 10. FIG. 10 present the results of the above tests in ranges of 100-1000 ng AA and 1 μg-1 mg AA. The Y axis represents the relative optical absorption in the yellow to blue spectral change.

Such calibration curve may be used to determine the amount of AA in samples comprising an unknown concentration thereof.

### Example 8

### DNA Detection

Fluorescent chemochromic variable optical filters comprising the chemochromic material ethidium bromide (EB) were prepared so that the active region of each filter had 0.7 mg/cm2 of EB incorporated into a 70 micron layer of polyvinyl alcohol (PVA) cast onto a transparent polyethyleneterephthalate (PET) backing. Molecules of the EB are known to adhere to DNA strands and fluorescence under UV light. Each filter was applied, in turn, to the optical lens of a digital camera. An initial picture was taken prior to the exposure of the filter to samples comprising DNA (reference picture, Lambda HIND DNA from BioRad). The variable optical filter was then exposed to a certain DNA concentrations, wherein each variable optical filter in turn was exposed to a different concentration of DNA in a sample of 1 μL, placed on the filter in liquid form. For DNA fluorescence excitation a UV lamp (358 nm) was used (FIG. 12). A second picture was taken after the exposure of the variable optical filter to the sample. The initial picture was compared to the second picture using image analysis software, thus measuring the visual difference caused by the exposure of the chemochromic material to the water based solution of DNA. Since the above tests were performed using known concentrations of DNA, the results were used to prepare the calibration curves shown in FIG. 11. FIG. 11 present the results of the above tests in ranges of 10-1000 ng DNA. The Y axis represents the relative fluorescent emission in the red spectral.

Such calibration curves may be used to define the DNA in samples comprising an unknown DNA thereof.

### Example 9

### Lead Detection

Chemochromic variable optical filters comprising the chemochromic material sodium sulfide were prepared so that the active region of each filter had 0.5 mg/cm2 of sodium sulfide incorporated into a 50 micron layer of polyvinyl alcohol (PVA) cast onto a transparent polyethylene terephthalate (PET) backing. Each filter was applied, in turn, to the optical lens of a digital camera. An initial picture was taken prior to the exposure of the filter to a lead acetate water based solution (reference picture). The variable optical filter was then exposed to a certain concentration of lead acetate, wherein each variable optical filter in turn was exposed to a different concentration of lead in a sample of 10 μL, placed on the filter in liquid form. A second picture was taken after the exposure of the variable optical filter to the sample. The initial picture was compared to the second picture using image analysis software, thus measuring the visual difference caused by the exposure of the chemochromic material to the lead acetate. Since the above tests were performed using known concentrations of lead acetate, the results were used to prepare the calibration curves shown in FIG. 13, presenting a concentration range of 1 nM-1 mM.

Such calibration curves may be used to determine the amount of lead acetate in samples comprising an unknown concentration thereof

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The applicant reserves the right to pursue such inventions in later claims.

We claim:

1. A method for detecting at least one analyte in a sample, the method comprising
applying a variable optical filter, which comprises a chemochromic material that is sensitive to the analyte, to an optical lens of a camera, an optical lens of a multi-cell photosensor or a multi-cell photosensor;
contacting at least part of the chemochromic material with the sample;
exposing at least part of the variable optical filter to electromagnetic radiation after at least part of the chemochromic material was exposed to the sample to obtain digital data regarding the chemochromic material that was contacted with the sample; and
processing the digital data and comparing said digital data with a reference.

2. The method according to claim 1, wherein the digital data is processed and compared to the reference using image analysis software.

3. The method according to claim 1, wherein the camera is a digital camera incorporated into a digital device having a screen and comprising image analysis software, wherein the image analysis software provides graphic, numeric or both graphic and numeric results, presented on the screen of the digital device.

4. The method according to claim 1, wherein the reference related to digital date recorded after applying the variable optical filter to the optical lens of the camera and before contacting the chemochromic material with the sample.

5. The method according to claim 1, wherein the reference corresponds to areas on the variable optical filter that do not comprise chemochromic material.

6. The method according to claim 1, wherein the reference corresponds to areas on the variable optical filter that are covered by a mask.

7. The method according to claim 1, wherein the reference relates to digital data stored in digital memory, which was obtained through a variable optical filter that was not contacted with the analyte.

8. The method according to claim 1, wherein the variable optical filter is disposable.

9. The method according to claim 1, wherein the image analysis software provides qualitative data, quantitative data or both qualitative and quantitative data.

10. The method according to claim 1, wherein the electromagnetic radiation is provided by a flash.

11. The method according to claim 1 wherein the variable optical filter is radiated by a UV or IR source, a visible light source, X-rays or any combination thereof.

12. The method according to claim 1, wherein the variable optical filter includes a backing and an upper layer coated thereon, wherein the upper layer includes the chemochromic material.

13. The method according to claim 12, wherein the upper layer further includes at least one additional substance.

14. The method according to claim 1, wherein the sample is a gas, volatilized liquid, airborne solid particles, suspension, powder, liquid, solid, gel, cream, plasma, flame or any combination thereof.

15. The method according to claim 1, wherein the variable optical filter is contacted with the sample by exhaling breath.

16. The method according to claim 1, wherein the sample has a predefined volume.

17. The method according to claim 1, wherein the variable optical filter includes a multiple number of chemochromic materials, designed to detect a multiple number of analytes simultaneously.

18. The method according to claim 1, wherein the analyte is a volatile sulfur compound, alcohol, ethyl glucuronide, acetone, hydrogen, methane, carbon monoxide, carbon dioxide, benzene, a volatile organic compound, a heavy metal or an industrial pollutant.

19. A kit comprising a variable optical filter, which comprises a chemochromic material that is sensitive to an analyte, an applicator or means for applying the variable optical filter to an optical lens of a camera or to a multi-cell photosensor, wherein the kit, the variable optical filter as packaged in the kit or both kit and variable optical filter as packaged in the kit are impermeable to the analyte.

20. The kit according to claim 19, wherein the means for applying the variable optical filter to the optical lens of a camera or the multi-cell photosensor is incorporated into or onto the variable optical filter.

21. The kit according to claim 19, wherein the kit includes means of contacting the variable optical filter in a controlled way with the analyte sample.

22. The kit according to claim 19, wherein the kit further includes a user instruction leaflet.

23. The kit according to claim 19, wherein the kit further includes a background.

24. The kit according to claim 19, wherein the variable optical filter is disposable.

25. The kit according to claim 19, further comprising a calibration scale relating to the concentration of the analyte.

26. The kit according to claim 19, further comprising reference data.

27. The kit according to claim 19, further comprising a calibrated volume balloon, a pipette or both a calibrated volume balloon and a pipette.

28. The method according to claim 1 wherein the variable optical filter is exposed to electromagnetic radiation generated from within the camera or the multi-cell photosensor, from outside the camera or the multi-cell photosensor or both from within and from outside the camera or the multi-cell photosensor.

29. The method according to claim 1, wherein the variable optical filter is transparent or translucent.

30. The method according to claim 1, wherein the variable optical filter is porous.

31. The method according to claim 1, wherein the variable optical filter is not sensitive to materials other than the measured analyte, including humidity.

32. The method according to claim 1, wherein the variable optical filter is designed for multiple uses.

33. The method according to claim 1, wherein the variable optical filter is reset to its original optical state after contacted with the sample and obtaining digital data regarding the chemochromic material that was contacted with the sample, by heat, vibration, ultrasound, chemical reaction, microfluidic system, microwave, a diode or any combination thereof.

34. The method according to claim 1, wherein the variable optical filter has a thickness that is probed in its entirety by electromagnetic radiation, such that the electromagnetic radiation is transmitted through the variable optical filter.

35. A device comprising at least one embedded multipixel photo electronic sensor coupled to a variable optical element.

36. A method for detecting at least one analyte in a sample, the method comprising:
attaining a variable optical filter, which comprises a chemochromic material that is sensitive to the analyte;
contacting at least part of the chemochromic material with the sample;
applying the variable optical filter to an optical lens of a camera and/or to a multi-cell photosensor;
exposing at least part of the variable optical filter to electromagnetic radiation to obtain digital data regarding the chemochromic material that was contacted with the sample; and
using image analysis software to compare the digital data with a reference.
